(19) United States
(12) Patent Application Publication
(10) Pub. No.: US 2008/0120903 A1
(43) Pub. Date: May 29, 2008

(54) Floatable growth tray

(75) Inventors: David M. Fair, Elkhart, IN (US); Craig R. Siders, South Bend, IN (US)

Correspondence Address: REISING, ETHINGTON, BARNES, KISSELLE, P.C., P O BOX 4390, TROY, MI, 48099-4390, US

(73) Assignee: WVP Acquisition Corporation

(21) Appl. No.: 11/604,463

(22) Filed: Nov. 27, 2006

(51) Int. Cl. A01G 9/02; A01G 25/00

(52) U.S. Cl. 47/65.7; 47/79; 47/73; 47/87

(57) ABSTRACT

A floatable growth tray for the germination of seedlings has a plurality of cells adapted to receive a mixture of a growth median and seeds. The tray has sealed pockets forming air chambers to enable the tray to float. The cells have holes forming openings extending through a bottom surface of the tray permitting water to enter the cells to promote germination of the seeds.

### FIELD OF THE INVENTION

This invention relates generally to a floatable growth tray for the germination of seedlings.

### BACKGROUND OF THE INVENTION

Growth trays for the germination of seedlings are in wide spread use and are well known in the industry. However seedling trays typically are made of a light weight expanded polystyrene foam and are not reusable or at best are capable of only limited reuse. As a result, the trays are discarded after very little if any reuse and have to be replaced at some considerable expense. Another disadvantage of growth trays made of polystyrene is that the roots of the seedlings sometimes grow into the polystyrene foam making it difficult to get the roots out without injury and without damaging the polystyrene foam.

### SUMMARY OF THE INVENTION

In accordance with the present invention, a floatable growth tray is provided having a plurality of cells adapted to receive a mixture of growth medium and seeds, wherein the tray has sealed pockets forming air chambers to enable the tray to float. Preferably the cells have holes forming openings extending through the bottom of the tray to permit water to enter the cells to promote germination of the seeds.

Further in accordance with the invention, the tray has a top sheet formed to provide a plurality of upwardly-opening cells adapted to receive the mixture of growth medium and seeds. A bottom sheet is secured to the top sheet. The two sheets have portions cooperating to provide sealed pockets forming the air chambers. The top and bottom sheets have aligned openings communicating with the cells to permit water to enter the cells.

Preferably the top surface of the tray is coated with an ultraviolet inhibitor to give the tray ultraviolet stability in sunlight.

Further in accordance with the invention, the top and bottom sheets are each formed of a mixture of virgin ABS (acrylonitrile-butadiene-styrene) and regrind ABS. The bottom surface of the top sheet has a cap layer of virgin ABS, the top surface of the bottom sheet has a cap layer of virgin ABS, and the two cap layers are fused together under heat and pressure.

One object of this invention is to provide a growth tray having one or more of the foregoing attributes and capabilities.

Other objects, features and advantages of the invention will become more apparent as the following description proceeds, especially when considered with the accompanying drawings.

### BRIEF DESCRIPTION OF THE DRAWINGS

FIG. 1 is a perspective view of a growth tray constructed in accordance with this invention, shown floating in a body of water;

FIG. 2 is a bottom view of a top sheet forming part of the tray, as seen from the underside;

FIG. 2A is a fragmentary sectional view taken on the line 2A—2A in FIG. 2;

FIG. 3 is a perspective view of the underside of a bottom sheet forming another part of the growth tray, as seen from the underside;

FIG. 3A is a fragmentary sectional view taken on the line 3A—3A in FIG. 3;

FIG. 4 is a fragmentary sectional view taken on the line 4—4 in FIG. 1, showing a portion of the growth tray floating in a body of water; and

FIG. 5 shows the two sheets of the growth tray in section and separated from one another in an exploded view.

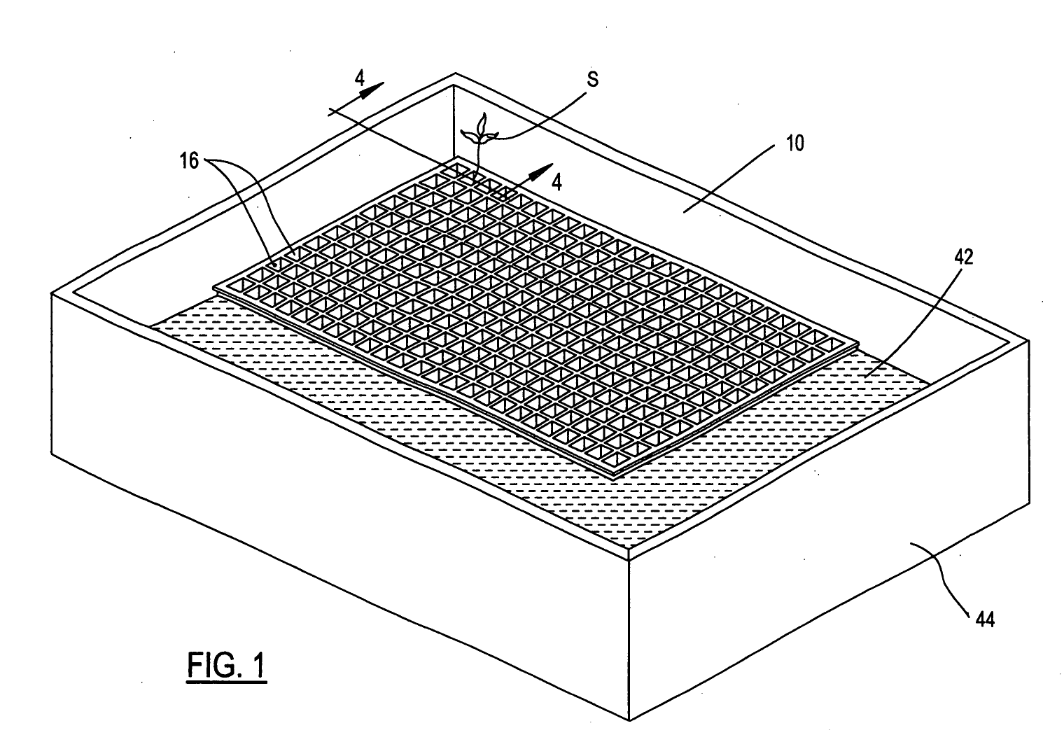

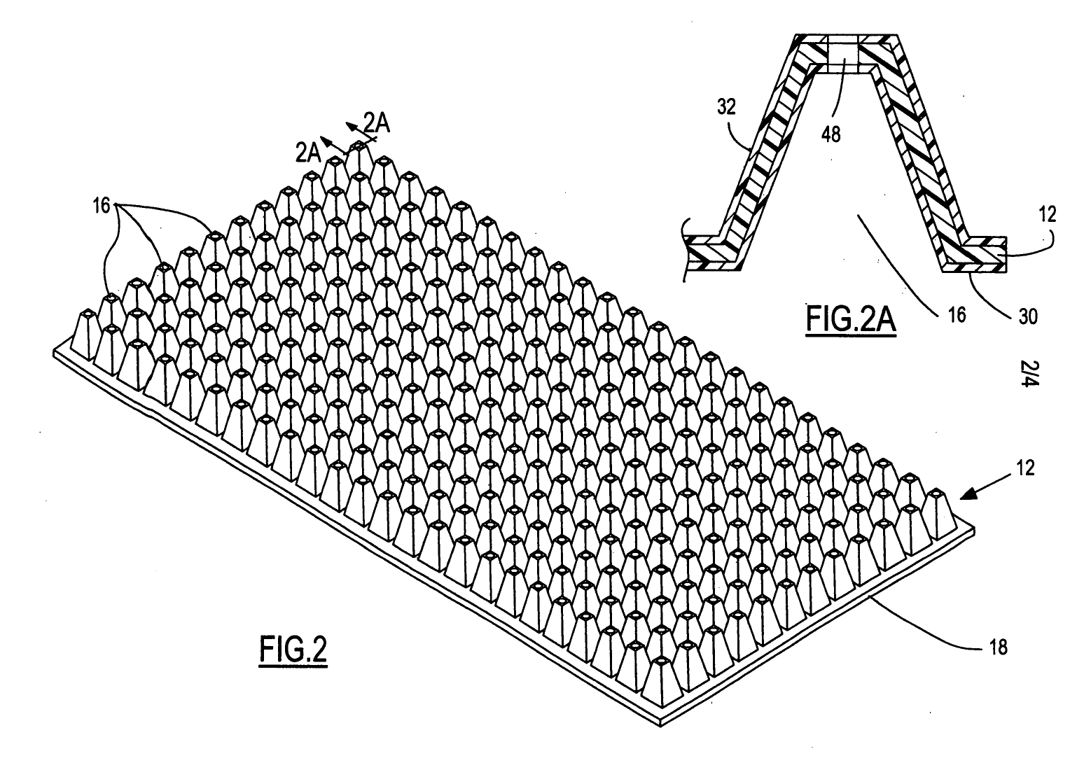

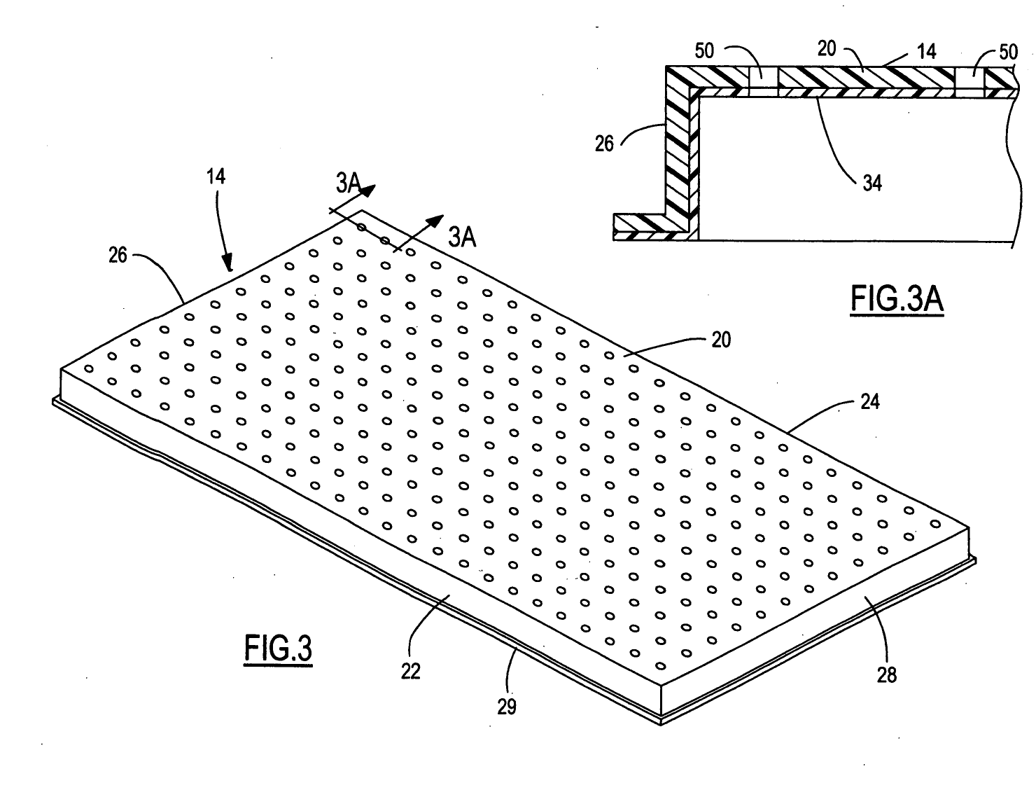

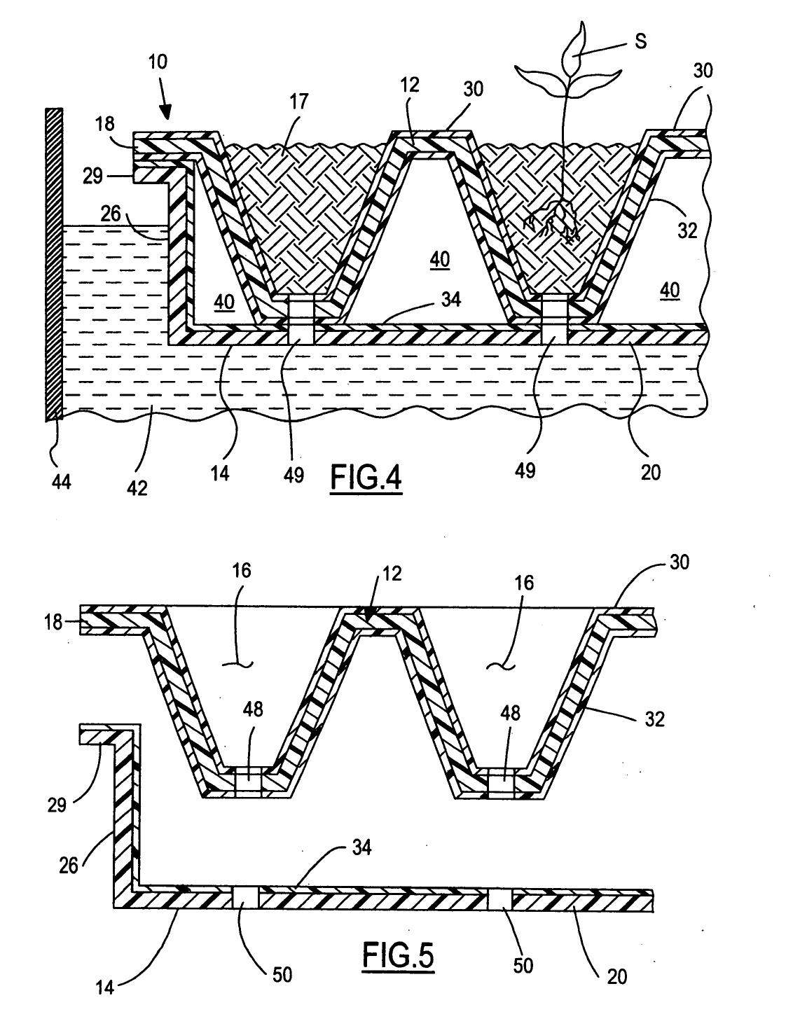

### DETAILED DESCRIPTION OF THE PREFERRED EMBODIMENT

Referring now more particularly to the drawings, the growth tray 10 is shown as a flat rectangular receptacle comprising a top sheet 12 and a bottom sheet 14 both made of a suitable molded plastic, preferably virgin acrylonitrile-butadiene-styrene (ABS) or a mixture of virgin ABS and regrind ABS.

The top sheet 12 is rectangular in shape and formed to provide a plurality of open-top cavities or growth cells 16. The cells 16 are adapted to be filled with seeds and a suitable growth median 17. The cells are tapered from top to bottom with four flat sides to force the roots of seedlings S to grow downward and enable the seedlings and growth medium to slide out easily when removed at planting time. Around its periphery, the top sheet 12 has a continuous, outwardly extending, horizontal rim 18. In the specific embodiment shown, there are 288 cells, each having a capacity of about 8.6 cc, although there can be a greater or lesser number of cells, as desired.

The bottom sheet 14 is rectangular in shape and has a substantially flat horizontal bottom wall 20, spaced apart parallel side walls 22 and 24 and spaced apart parallel end walls 26 and 28 extending vertically upwardly from the margins of the bottom wall. Around its periphery, the bottom sheet 14 has a continuous, horizontal rim 29 extending outwardly from the upper extremities of the side and end walls 22-28.

The top sheet 12 has an ultraviolet (UV) inhibitor covering the entirety of its top surface to provide the tray with UV stability in sunlight. The UV inhibitor is preferably provided by an opaque acrylic cap sheet 30 approximately 3 millimeters in thickness and bonded to the top surface of the top sheet 12 under heat and pressure during extrusion of the top sheet.

A cap sheet 32 covers and is secured to the entirety of the bottom surface of the top sheet 12. Preferably the cap sheet 32 is made of virgin ABS and is bonded to the bottom surface of the top sheet 12 by heat and pressure during the extrusion of the top sheet.

A cap sheet 34 covers and is secured to the entirety of the top surface of the bottom sheet 14 and is preferably made of virgin ABS and is bonded to the top surface of the bottom sheet 14 under heat and pressure during the extrusion of the bottom sheet.

The top and bottom sheets 12 and 14 are secured to one another by fusing the cap sheets 32 and 34 of the top and bottom sheets together under heat and pressure and in the process forming sealed pockets 40 which form air chambers to enable the tray to float. The tray is shown floating in a body of water 42 in a vat or container 44.

The bottom wall 46 of each cell 16 has a hole 48 extending through the top sheet 12 and through the cap sheets 30 and 32. The bottom wall 20 of the bottom sheet 14 has holes 50 extending through the bottom wall 20 and through the cap sheet 34. The holes 50 are respectively aligned with the holes 48 to form openings 49 to permit water to enter the cells and promote germination of the seeds.

In use, the cells 16 are loaded with seeds and a suitable growth median 17. The tray or receptacle 10 is then floated in water. The growth median becomes saturated with water which enters the cells 16 through the openings 49 to start the germination process. When the seedlings S are grown sufficiently, the tray 10 is removed from the water and the growth median 17 and seedlings S are removed from the cells 16. The roots of the seedlings S are prevented from penetrating into the material of the tray 10 by the cap sheet 30. The virgin ABS material of the cap sheet 30 provides a hard smooth surface resistant to penetration. The tray 10 is buoyant due to the presence of the pockets 40 forming air chambers and will support the weight of the tray plus the weight of the saturated growth median and seedlings. The tray can be reused many times and ultimately can be recycled.

What is claimed is:

1. A floatable growth tray for the germination of seedlings, comprising:
a generally flat receptacle having a plurality of cells adapted to receive a mixture of a growth median and seeds,
said receptacle having sealed pockets forming air chambers to enable the receptacle to float in a body of water, and
said cells having holes forming openings extending through a bottom surface of the receptacle permitting water to enter the cells to promote germination of the seeds.

2. The floatable growth tray of claim 1, wherein said cells are formed by open-top recesses in a top surface of the receptacle.

3. The floatable growth tray of claim 1, wherein the top surface of the receptacle is coated with an ultraviolet inhibitor to give the receptacle ultraviolet stability in sunlight.

4. The floatable growth tray of claim 1, wherein said cells are downwardly tapered to cause seedling roots to grow downward and to facilitate removal of the seedlings.

5. The floatable growth tray of claim 1, wherein said cells form open-top recesses in a top surface of the receptacle, the top surface of the receptacle is coated with an ultraviolet inhibitor to give the receptacle ultraviolet stability in the sunlight, and said cells are downwardly tapered to cause seedling roots to grow downward and to facilitate removal of the seedlings.

6. A floatable growth tray for the germination of seedlings, comprising:
a generally flat receptacle having a top sheet formed to provide a plurality of upwardly-opening cells adapted to receive a mixture of growth medium and seeds,
a bottom sheet beneath and secured to the top sheet,
said top and bottom sheets having portions cooperating to provide a plurality of sealed pockets forming air chambers to enable the receptacle to float in water, and
said top and bottom sheets having aligned openings communicating with said cells permitting water to enter the cells to promote germination of the seeds.

7. The floatable growth tray of claim 6, wherein said top and bottom sheets are each formed of ABS.

8. The growth tray of claim 7, wherein said top and bottom sheets are fused together under heat and pressure.

9. The floatable growth tray of claim 6, wherein said top and bottom sheets are each formed of a mixture of virgin ABS and regrind ABS, the bottom surface of the top sheet has a first cap sheet of virgin ABS, the top surface of the bottom sheet has a second cap sheet of virgin ABS, and said cap sheets are fused together under heat and pressure.

10. The floatable growth tray of claim 9, wherein the top surface of the top sheet is coated with an ultraviolet inhibitor to give the top sheet ultraviolet stability in sunlight.

11. The floatable growth tray of claim 10, wherein said ultraviolet inhibitor comprises an opaque acrylic cap sheet.

12. The floatable growth tray of claim 11, wherein said cells are downwardly tapered to cause seedling roots to grow downward and to facilitate removal of the seedlings.
